(19) United States
(12) Patent Application Publication
(10) Pub. No.: US 2013/0047089 A1
(43) Pub. Date: Feb. 21, 2013

(54) System and Method to Consolidate and Update Digital Address Books

(71) Applicant: MURALI S. KULATHUNGAM, HERNDON, VA (US)

(72) Inventor: MURALI S. KULATHUNGAM, HERNDON, VA (US)

(21) Appl. No.: 13/214,215

(22) Filed: Aug. 21, 2011

(51) Int. Cl. G06F 3/00

(52) U.S. Cl. 715/739

(57) ABSTRACT

Computer software applications, systems and methods for managing contact information online in a central database, and automatically updating information on addressees' online communications accounts, such as their Gmail®, Yahoo®, LinkedIn®, and Facebook® accounts. The present invention incorporates online email accounts, social network accounts, and personal information managers into a central address book stored on a server database that is accessible from users' workstations and mobile devices. Users may set permission levels for access to their contact information by addressee category and/or customize it to each addressee. Users may also post updates to their contact information into their addressees' online accounts if the addressee is a member of the system database who has granted permission for automatic updates to their email accounts, social network accounts, and the like. Alternatively, the system will automatically generate an email to addressees requesting that they manually enter the user's update into their online communications accounts.

### FIELD OF THE INVENTION

The present invention relates generally to computer software applications, systems and methods for managing contact information via synchronization of contact information between unrelated online email accounts, social network accounts, and personal information managers.

### BACKGROUND

Today, most users of electronic communications devices possess multiple address books that store their contact information for friends, family, professional associates, etc. . . . . The address books may reside in a variety of locations (such as within cloud computing platforms, stored in laptop computers databases, mobile device memory, social networking websites, and the like). Possessing multiple address books is an extremely inefficient and unreliable method for a user to keep abreast of their contact information. The user must know which of their accounts to access to obtain a particular addressee's information. They must also take repetitive steps to update their contact information in each of their accounts. For example, if a user were to obtain a new private email address, they would need to update each of their accounts separately with the new address (e.g., Gmail®, Facebook®, LinkedIn®, etc. . . . ).

The user also faces the difficulty of controlling what types of their contact information are available to each of their addressees. For example, a user may wish to disclose only their mobile phone number and private email account to friends; their home phone and mailing address to family; and their work address, work phone number, and professional email address to professional associates.

Once a user has determined which elements of their contact information are to be made available to specific addressees, then the user has to communicate any data changes to their addressees. It then becomes the responsibility of the addressees to manually update their address books to make sure that they are up-to-date. This involves effort on the part of the user and their addressees.

Therefore, there is a need within the art for an automated method of compiling and updating a user's contact information from all of a user's digital communications accounts, while also permitting them the ability to designate what types (e.g. data elements) of their information are shared with each of their addressees. The digital address book also needs to be accessible and updatable from a variety of computing devices (e.g., workstations, smartphones, tablets, etc. . . . ). Any updates that are made to a user's personal contact information should be pushed automatically to their addressees' address books. Addressees who do not wish to receive automated updates can receive notification emails advising them of the changes that are generated by a system server.

### SUMMARY OF THE INVENTION

The present invention comprises contact information management computer software, systems and methods that incorporate synchronization of contact information between unrelated online email accounts, social network accounts, and personal information managers. In addition, it provides the ability for User A to automatically update their contact information in User B's (e.g. “the addressee's”) online address books without User B's intervention.

In further detail, the present invention comprises networked based systems, methods, and computer program products for creating and maintaining a contact management system by importing into and updating a system database with a user's contact information from: 1) digital address books stored on a user's computing device (e.g., Microsoft® Outlook); 2) a user's online address books (e.g. Hotmail®, Gmail®, Yahoo® Mail, etc. . . . ); and 3) a user's social network accounts (Facebook®, LinkedIn®, etc. . . . ). In addition to a software application downloaded to the user's mobile device, the user may manage their contact information that is stored on the system database by logging into a hosted website.

The present invention further comprises enhanced identity security by ensuring that a user has rights to an account before importing the stored contacts from the account into the system database. For example, rights may comprise account login and password.

The present invention also comprises providing the user the ability to set permission levels, or to assign access privileges to their contact information data elements, on a addressee category basis or customized to each addressee. For example, all addressees designated within the same class, such as “Friends”, are provided the user's personal email, home mailing address, home phone number, versus “Professional Associates”, who are provided the user's work email, address, and number. Alternatively, or additionally, the user may set the privilege levels on a customized basis for each addressee stored within their account on the system database, wherein they select each specific data element that a particular addressee may view.

The methods and systems of the present invention further comprise a means of automatically updating an addressee's online address books (e.g. Gmail®, Yahoo Mail®, etc. . . . ) with changes made by a user to a data element of their contact information stored on the system database. If a user's addressees have an account on the contact management system database, and if they have elected to receive automatic updates to their account, then the system will log into their online address books (e.g. email accounts), and automatically update the user's contact information. The addressees may notified that an update has been made in their address book to the user's contact information via methods well known in the art (Instant Messaging, SMS, email, etc. . . . by the system server). In an alternative embodiment of the present invention, when the addressees logs into their online address book they will be asked to accept the user's update. And for situations wherein the addressees do not have an account on the system database, or do but have not elected to receive automatic updates, then a message (e.g. email) is sent to the addressees from the system server requesting that they manually update the user's contact information within their digital address books.

The present invention is also compatible with automatically updating a user's contact information on their social network accounts (e.g. Facebook®, LinkedIn®, etc. . . . ). Likewise, the user's update will be automatically be made in an addressee's social network account (e.g. a user's email address in LinkedIn®), if the addressee has set their system account to receive automatic updates. Otherwise, they will receive an email message in their LinkedIn® account requesting that they manually enter the change of the user's email address.

In an alternative embodiment of the present invention, changes the user has made to their account on the system database, are pushed to the user's online accounts as per their designated privilege levels set on the database. So when a user inputs a change in their contact information on the system database, then the system server will automatically log into their social network accounts and update the data element, but only if it is given as a type of contact information within the user's social network account. For example, if a user updates their home mailing address and mobile phone number on the system database, the system server will subsequently log into the user's Facebook® account to make the updates for the types of contact information that the user presently discloses on their social account. If, for example, the user's Facebook® account discloses their mobile phone number, but not their mailing address, then the system server will only update the mobile number. The home mailing address field will remain blank on the user's Facebook® account contact information webpage.

All aspects of the present invention are functional on mobile computing devices comprising a computer program product of the present invention and web browser with Internet access, such as a personal digital assistance (PDA) or smartphone (e.g. devices having a mobile operating system comprising Windows Mobile, iPhone OS, Google's Android, Symbian OS, RIM's BlackBerry, Palm's WebOS, Linux, etc. . . . ). A user can create, manage, update their account, and receive updates from addressees who have system accounts. A computer program product is downloaded to the mobile device, wherein the contact information on the mobile device is periodically synched with the central database so that modifications made on the mobile device are saved in the system database. Alternatively, the user may utilize the web browser of the mobile device to log into their account on the system server and make updates to their central address book in the system database.

All of the user's contact information accounts (e.g., stored on mobile device address book, within the user's online email accounts, and the users social networking accounts) may be periodically synched with the central database so that modifications made on the user's accounts after the initial setup will be made in the system database. These modifications will then be automatically or manually updated in the addressees' online account in accordance with the steps of the present inventions.

According to yet another aspect of the invention, a software program or application with software modules is provided comprising program code means stored on a readable medium for carrying out the method of the preceding description when said program is run on a client computing device (e.g. mobile device) and/or the system server. The modules on both the mobile device application and system server comprise: an “Account Creation and Consolidation of Contact Information”; “Setting of Addressee Privilege Levels”; “Automatic Updating of Addressee Online Accounts”; and “Manual Updating of Addressee Online Accounts via an Email Message”.

### BRIEF DESCRIPTION OF THE DRAWINGS

The methods, systems, and computer programs that embody the above and other inventive features will now be described with reference to the following drawings:

FIG. 1 is a detailed block diagram showing a configuration of the system server components in communication with users' mobile device and laptop computer in a preferred embodiment of the present invention.

FIG. 2 is a detailed block diagram showing a configuration of the user's client computer (laptop or desktop) in a preferred embodiment of the present invention.

FIG. 3 shows a schematic diagram of a mobile device in accordance with one implementation of the present invention.

FIG. 4 illustrates a flowchart for a user to create a contact management account and import their online address books and social network accounts.

FIG. 5 illustrates a flowchart for a user to update a data element within their contact information stored on the system database, and for the system to log into the addressee's account and update the user's information.

### DETAILED DESCRIPTION

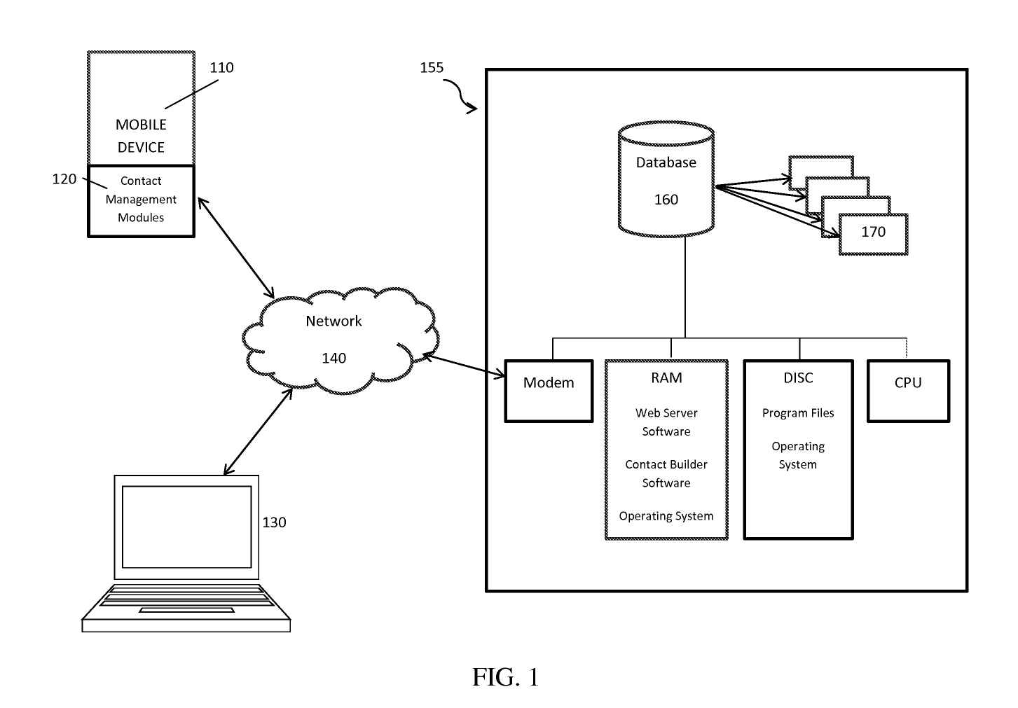

The embodiments described below and in the claims refer to a system server housing a database of users' contact information consolidated from a multitude of a user's digital accounts, wherein the system is in communication over a network with one or more user client computers (e.g. laptops and smartphones) as illustrated in FIGS. 1-3.

### System Architecture

The present invention comprises a client computing system in communication via a network with a server system housing a database of users' contact information consolidated from their various contact information accounts into a central address book. In a preferred embodiment of the present invention, the software computer program runs on the system server and is accessed through the client computer's web browser. The contact management features of the present invention may also be accessed through automated web services. And in situations wherein the client computing system is a mobile device with web browser capabilities (e.g. a smartphone), an application program provides full functionality of the present invention to run computer programming modules on the client device or on the system server. The application and the system software computer program comprise a computer readable medium containing computer executable instructions to carry out the methods of creating, accessing, and updating a central address book in accordance with the present invention.

Software and Modules

In the present invention, a “module” is herein defined as a portion of a computer program that carries out a specific function and may be used alone or combined with other modules of the same program. Likewise, “software” comprises program instruction adapted for execution by a hardware element, such as a processor, wherein the instruction comprise commands that when executed cause the processor to perform a corresponding set of commands. The software may be written or coded using a programming language, and stored using any type of computer-readable media or machine-readable media well known in the art. Examples of software in the present invention comprise any software components, programs, applications, computer programs, application programs, system programs, machine programs, and operating system software.

The Client System

The system may comprise many users, each with a client computer executing the application and capable of communicating with the server system. Herein the term “client” computer shall be used to represent any local computing device such as a smartphone, hand-held “palm top” computer, laptop computer, desktop computer, terminal, PDA (Personal Digital Assistant), PIM (Personal Information Manager), Network computer, wireless communicator (such as a cellular or satellite telephone), or a multi-user computing system, etc. which is capable of communicating with a remote or server computer via the remote network. The client computer may contain an output device such as a CRT or LCD screen or plasma display, a manual data entry device such as a keyboard, keypad, touch screen, voice recognition system, pen stylus, or other such manual input devices as are commonly known in the art. The client computer may comprise a mobile device running an application comprising the contact management modules of the present invention.

A mobile device client computer has a secondary memory device, such as, for example, a hard disk drive or other non-volatile memory. The client program of the system is stored on the secondary memory device of the client computer, such as a mobile device (e.g. smartphone) and is executed by the client computer's processor. It will be appreciated by one with skill in the art that the application might be installed on the client computer from a number of sources such as, for example, downloaded over the Internet from a server, or bundled with software provided by a third party software manufacturer (such as a Web browser provided by a Web browser manufacturer). It will be appreciated that the application will function in substantially the same manner regardless of the installation source or method.

The Server System

As used herein the term “server” computer is used to describe any computing device that stores and runs a computer program of the present invention, houses the system database, and communicates periodically with the client program. The server system facilitates the collection and distribution of content to and from a multiplicity of client computers. The system server computer consists of one or multiple high speed CPU's (Central Processing Unit(s), primary memory (i.e. RAM) and secondary storage device(s) (i.e. hard disk drives). The application programs, operating system and the database management programs may all run on the same computing device as in a traditional “main frame” type of configuration or several, individual yet interconnected computing devices as in a traditional “multi-tier client-server” configuration as is well known in the art. The server system is coupled to the remote network (such as the Internet). The server system executes a (or multiple depending on the server system configuration) server program(s). The server system and the client program have communications facilities to allow client computers to connect to and communicate with the server program(s) such that the server program(s) can communicate with and exchange information with a multiplicity of client programs.

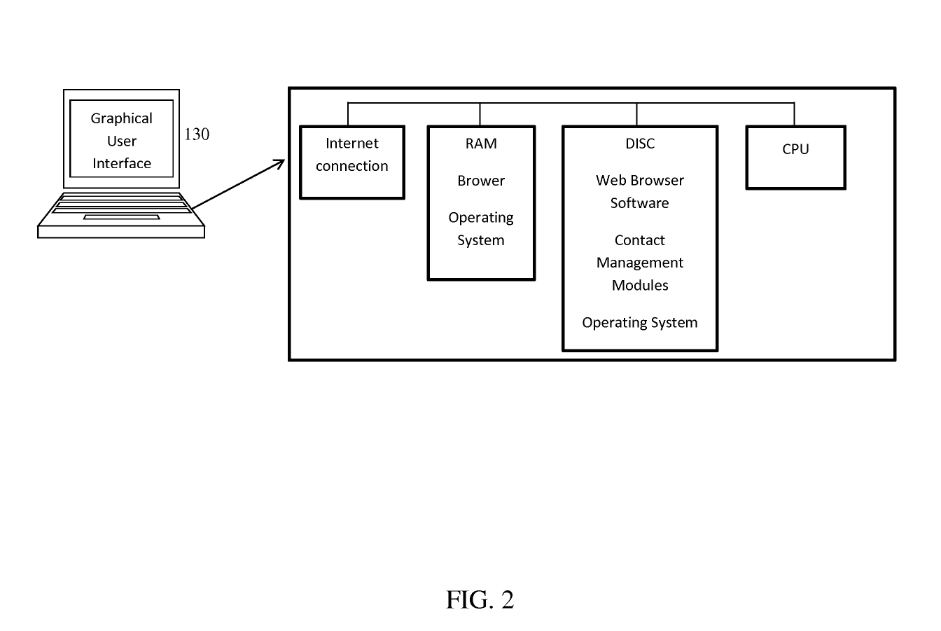

By way of exemplification, the system of the present invention as illustrated in FIG. 1 comprises the following components. A Network (Internet) 140 wherein the term “network” is used to describe any public network such as the Internet or World Wide Web or any public or private network as may be developed in the future which provides a similar service as the present Internet. The client (user's) computer may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the network (i.e. the Internet). A system server 155 comprising: a modem or other device for connecting to the computer network, a random access memory (RAM) for program execution, a hard disc for program storage, central processing unit (CPU), and a system database of user contact information and their relationships. The system comprises web server software, and contact management software of the present invention. The user's “central address book” is stored within their account on the system database. A user client computing device 130 comprising a communications device with web browser capabilities (e.g., desktop or laptop) configured to communicate with the server system via the internet to enable users to create and update their contact information account on the central database. The contact management modules may also be downloaded to the client computer to access and update the user's contact information when the device is not connected to the internet. The user client computing device is further illustrated in FIG. 2. It comprises a central processing unit (CPU); a primary-random access memory (RAM) for program execution of web browser and the client operating system; a second storage device (hard disc) for program storage of local data (optional), web browser software, contact management software, and disc operating system; a user interface; and a modem or other device for connecting to the computer network. And a user mobile device (e.g. smartphone) 110 as shown in FIG. 1 configured to communicate with the central server database over a wireless communication network. A mobile computing device, such as a smartphone, may have voice and data communications capabilities. The device may also possess processing capabilities that allow the device to store and execute the contact management modules 120 of the present invention.

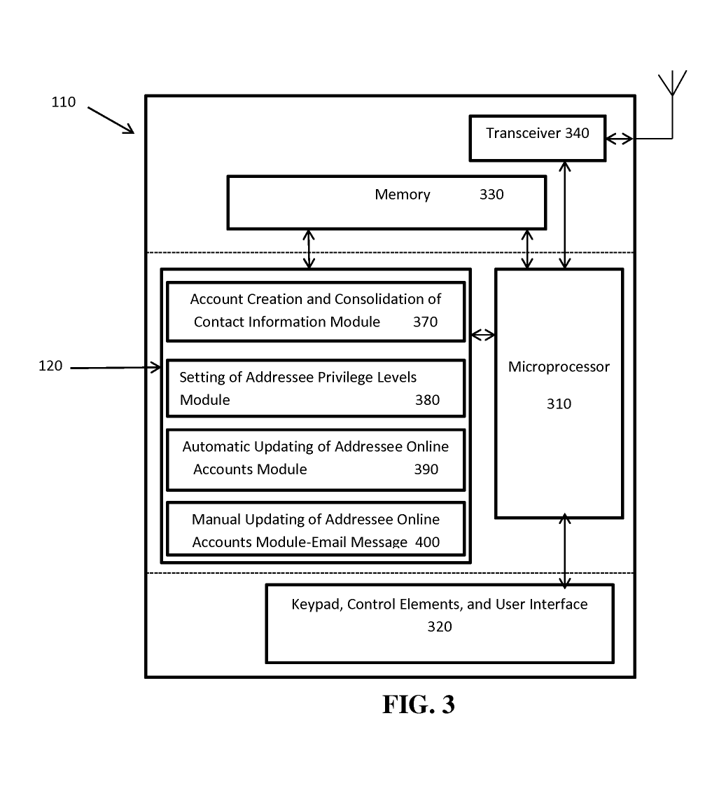

As illustrated further in FIG. 3, the system architecture of mobile communications device 110 suitable for the present invention is well known in the art, and comprises: a micro-processor 310; a user interface with data input keypad 320; memory 330 such as random access memory (RAM), read only memory (ROM), nonvolatile memory such as EPROM or EEROM, flash memory or hard drive memory; and a transceiver 340 functionally connected to an antenna to receive and transmit data in a wireless network. The transceiver may operate according to standards commonly known in the art by the skilled practitioner, such as for GSM, GPRS, wireless local and personal area network standards, and Bluetooth. The mobile device of the present invention may further comprise contact management modules that interface with a wireless network to allow a user of the mobile device to create their system account, to access and view addressee information as needed, to manually make updates to their account on the database, to automatically receive updates of other addressees on the database, and to periodically and automatically synch contact information stored on their mobile with the system database. Contact management modules of the present invention may further comprise: (1) an account creation module for users to consolidate their online email accounts, social network contacts, and personal information managers into one virtual address book stored on said database 370; (2) a module for users to designate privilege levels to permit addressees access to their stored contact information 380; (3) a module for users to automatically update their contact information in their addressees' online contact information accounts 390; and (4) a module for the system server to generate an electronic message to an addressee, who does not have a system account, or does and has declined to receive automatic updates, instructing the addressee to manually enter the update 400.

### User Account Setup

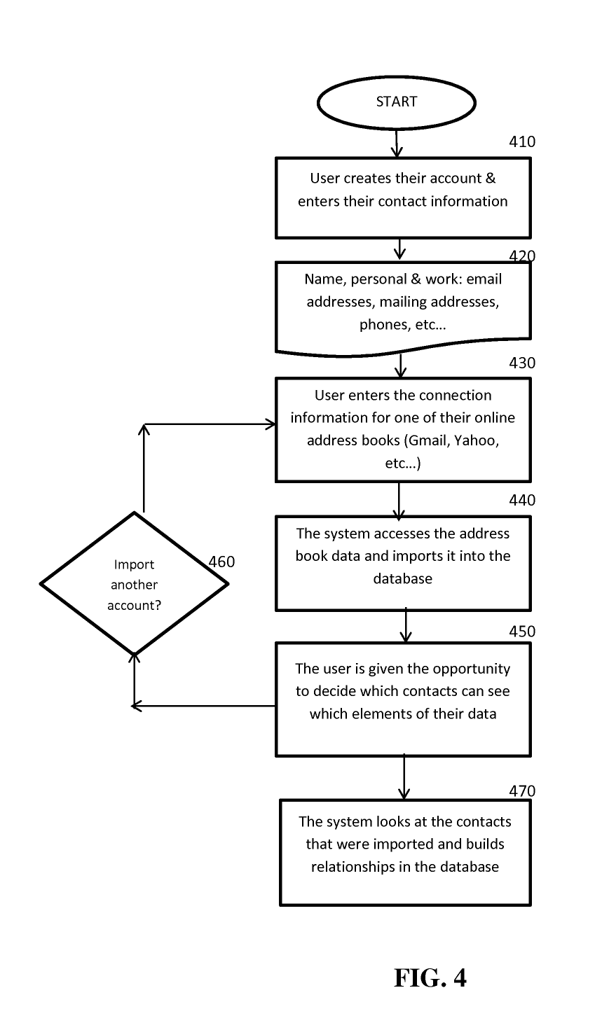

The methods and system of the present invention comprise the user creating an account on the system server. As illustrated in FIG. 4, the user creates an account 410 by, for example, registering at the system website and selecting a username and password. They then manually enter their individual contact information 420 comprising: their name, addresses (home, work, mailing, etc. . . . ), phone numbers (home, mobile, work, work mobile, fax, Skype®, etc. . . . ), email addresses (personal, work, etc. . . . ), and social networking addresses (Facebook® contact address, etc. . . . ). The user then enters the connection information, such as their login identification and password, for one of their online address books (e.g., Gmail®, Yahoo Mail®, etc. . . . ) 430. The system server inputs the connection information to access the online address book, and imports the user's contact information into the system database 440. The user sets privileges levels for each imported contact/addressee by designating what types of their individual contact information that they entered into the system database (see FIGS. 4, 410 & 420) may be viewed by each of their addressees 450. The privilege levels may be set by the type of relationship an addressee has to the user (e.g. all addressee's designated by the user as “Friend” have access to the same type of user personal information); or, the privilege level may be customized for each addressee by manually selecting each data element of a user's contact information a particularly addressee my view. The user is then given the opportunity to import another online address book 460, as in FIG. 4, 430. Once all of the online address books (including personal information managers residing on the client computer) have been imported into the system database and the user has designated privilege levels for each addressee or addressee category type, then the system builds relationships in the system database 470. By way of exemplification, relationship building may comprise a situation in which a new addressee is added to a user's contact list. The system will use that addressee's email address or other semi-unique value to identify if that addressee exists in the system database. The system will then create a virtual link between the user and the addressee so that updates can be pushed easily between the two accounts as necessary. The relationships will identify who the two users are in the relationship, whether both users are in the system or not and, if they're both in the system, the nature of their relationship (User A has User B—“Addressee”—as Friend; Addressee has User A as Coworker).

In an additional embodiment of the present invention, addressees within a user's social network sites (e.g., Facebook®, LinkedIn®, etc. . . . ) may be incorporated into the user's account on the system database. The process is similar to that exemplified in FIG. 4, wherein the user enters the connection information (e.g. their login and password) to the social networking site 430. The system server accesses the list of addressees within the social networking site (e.g. “Friends”), and imports them into the system database 440. The user sets privileges levels for each imported addressee by designating what types of their individual contact information that they entered into the system database may be viewed by each of their addressees 450. The user is then given the opportunity to import another social network account 460. Once all of the social network accounts have been imported into the system database and the user has designated privilege levels for each addressee or category of addressees, then the system builds relationships in the system database 470.

### Privileges-Setting Addressee Access Rights

The privilege levels are set when the user creates their account on the system, but they may be changed at any time by the user logging into the system server. Privileges are set per addressee category type (e.g. friend, family, professional contact, etc. . . . ), and/or may be customized for each user data element per addressee (e.g. designates which data elements each contact may view). By way of exemplification, when the user creates their account, they designate that the category of addressees called “Friends” will have access to their personal contact information comprising the data elements of: home mailing address, private email accounts, mobile phone number, etc. . . . . At a later time, the user may change the settings on their system account to permit addressees labeled as “Friends” to have information for their mobile phone number and private email accounts, but not their home mailing address. Addressees accessing user contact information on the system database will no longer have access to the home mailing address. And addressees that have set their system account to permit automatic updates in their online accounts, will also not have access to this information due to the system removing the data when processing a user update.

In an additional or alternative embodiment of the present invention, the user may also have the ability to customize privilege rules per addressee. By way of exemplification, the user may set the system server to permit access of one particular friend “Bob” to their data elements home mailing address, private email account, and mobile phone number, but they may also designate that another friend “Anne” not be granted access to their home mailing address while still allowing her access to the user's private email account and mobile phone number.

### Automatic and Manual Updates to Addressees' Online Accounts

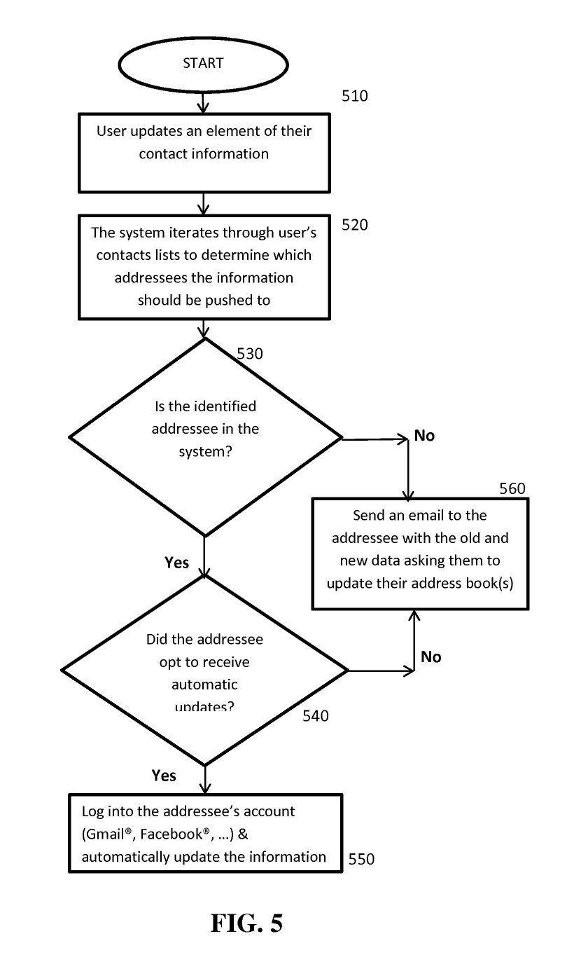

The present invention allows for both manual and automatic updating in a addressee's account of data elements changed by a user. FIG. 5 illustrates a preferred embodiment of the present invention for updating a user's contact information in an addressee's online address book. The method is initiated when a user updates a data element of their contact information that is stored on the system database, such as their home phone number (as shown in FIG. 5, 510). The system server then determines which of the user's addressees will be provided the update for that particular data element based upon privileges set by the user per category type (e.g. “Friend”) and/or by customized rules set by the user per each addressee (520). The system server then checks to determine if the addressee has an account in the system database (530). If “Yes”, then the system server checks to determine if the addressee set their account to receive automatic updates to their electronic communications accounts (540). If they did, the system will log into the addressee's online account (e.g., Gmail®, Yahoo Mail®, Facebook®, etc. . . . ) and automatically update the user's new data element (550). Alternatively, if the addressee does not have a system account (530, “No”); or does have a system account, but has elected to not receive automatic updates (540, “No”), then the system will send an email to the addressee with the user's old and newly updated data element, and request that the addressee manually update their online address book, social networking account, and/or personal information managers (560).

### Social Network Accounts

As stated supra, the flowchart of FIG. 5 items 510 thru 560 are also applicable to a user updating their contact information on the system database, and having the system server subsequently access an addressee's social network account (e.g. LinkedIn) to automatically update the User's changed data element (e.g. professional email address).

In an additional feature of the present invention, updates to a user's data elements within the system database may be posted to the user's social network sites (e.g., Facebook®, LinkedIn®, etc. . . . ) in accordance with the privilege levels set in the system account, and in accordance with the types of contact information posted on the user's social network account. After a user has stored the connection information for their social network account (e.g. login and password), then the system server will access the account and change their contact information as per their update. For example, if a user enters a new email address with a privilege level designated for “Friends” and “Family”, then the system server will automatically access the user's Facebook® account and update their listed contact email address, but will not access and update their professional addressees within their LinkedIn® account.

Additionally, the system server will only update a data element if it is already given as a type of contact information within the user's social network account. For example, if a user updates their home mailing address and mobile phone number on the system database, the system server will subsequently log into the user's Facebook® account to make the updates for the types of contact information that the user presently discloses on their social account. In this exemplification, the user's Facebook® account discloses their mobile phone number, but not their mailing address. The system server will then update the mobile number, but it will not update the mailing address. The home mailing address or city of residence field will continue to remain blank on the user's Facebook® account contact information webpage.

In a further feature of the present invention, the user's central address book is periodically updated with changes made in their online email accounts, social network accounts, and personal information manager. For example, when a user changes their contact information on their social network site, and the system server synchs with the user's online accounts to check for addressee or user updates made to a user's digital accounts, then the system will automatically update the user's account on the system database. For this to occur, the system server must periodically check a database account holder's online email accounts, social network accounts, and personal information managers for updates, and then import the updates into the database.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A method in a network computer system for a user to create a central address book on a system database consolidating said user's contact information from online email accounts, social network accounts, and personal information manager account, comprising:
a) on a client computer, creating a user account on the server by inputting name, login and password, and user's contact information; inputting connection information for a first digital address comprising web domain address; and providing proof that user has access rights to the online address book account by inputting said account login and password;
b) on the server, accessing said online address book data via the network; and
importing the stored contact information into the system database;
c) on the client computer, setting privilege levels for addressees' visibility of imported user contact information; and repeating steps (b) through (f) until all of a user's online address books are imported into the system server; and,
d) on the server, creating relationship tables between the user and each addressee stored within the user address book.

2. The method of claim 1, wherein setting privilege levels comprises a user granting access to each data element of a user's contact information in a manner customized for each addressee within the user's address book.

3. The method of claim 1, wherein setting privilege levels comprises a user granting access to the types of data elements of a user's contact information based on an addressee's category of relationship to the user.

4. A computer readable medium containing computer executable instructions to carry out the method of claim 1 when said instructions are run on a client computing system or network, said instructions downloadable from or stored on a system server.

5. A method in a networked computer system for updating a user's contact information in an addressee's online address book or social network account, comprising in order:
a) on a client computer, inputting an update to a data element in user's contact information; and transmitting said update to user's address book stored on the system database;
b) on system computer, identifying by the system which addressees may receive the user's update based on privilege levels designated for each addressee;
c) determining that if said identified addressees: (i) have an account on the system database and (ii) have setup their account to automatically receive updates into their online address books and social network accounts.

6. The method of claim 5 further comprising, if addressee has an account on the system database setup to automatically receive updates, logging into said addressee's online address books and social network accounts and automatically updating user's contact information.

7. The method of claim 5 further comprising, if addressee does not have an account on the system database, transmitting an email to said addressee requesting they input user's updated contact information into their online address books and social network accounts.

8. The method of claim 5 further comprising, if addressee does have an account on the system database that is not setup to permit automatic updates, transmitting an email to said identified addressee requesting they input user's updated contact information into their online address books and social network accounts.

9. A computer readable medium containing computer executable instructions to carry out the method of claim 5 when said instructions are run on a client computing system or network, said instructions downloadable from or stored on a system server.

10. A networked contact management system, comprising:
a) a server system comprising:
a central database storing user central address book and user designated privilege levels for sharing user contact information with addresses;
a contact manager software providing access to user's account on the database through a computer interface providing functionality for:
(i) a user to consolidate their online email accounts, social network contacts, and personal information managers into said central address book;
(ii) a user to designate privilege levels to permit addressees access to their stored contact information;
(iii) a user to automatically update their contact information in addressees' online contact information accounts with intervention from the addressees; and
(iv) the system to generate an electronic message to an addressee, who does not have a system account, or does and has declined to receive automatic updates, instructing the addressee to manual enter the update; and,
b) a client system comprising a user interface with web browsing capabilities and configured to communicate with the server system via the internet to enable users to create and update their central address book on said database.

11. The system of claim 10, wherein a user's contact information is automatically updated in an addressee's online account if said addressee has an account on said server system, and has elected to receive automatic updates, and has provided login information to their online accounts.

12. The system of claim 10, wherein designating privilege levels comprises a user customizing the access of an addressee to the user's contact information by granting or denying access to each of the user's data elements.

13. The system of claim 10, wherein designating privilege levels comprises a user granting access to the types of data elements of a user's contact information based on an addressee's category of relationship to the user.

14. The system of claim 10, wherein said client system is a mobile communications device with web browser capabilities and further comprising contact management modules enabling a user to create, access, and update their contact information on said system server.

15. The system of claim 14, wherein said contact management modules on said mobile communications device provide functionality for:
(i) a user to consolidate their online email accounts, social network contacts, and personal information managers into an address book stored within the database of the mobile device memory;
(ii) a user to designate privilege levels to permit addressees access to their stored contact information;
(iii) a user to automatically update their contact information in their addressees' online contact information accounts; and
(iv) the system to generate an electronic message to an addressee, who does not have a system account, or does and has declined to receive automatic updates, instructing the addressee to manual enter the update.

16. The system of claim 15, wherein the contact information on the mobile communications device and in the system server are periodically synched with the central database so that modifications made on the mobile device are saved in the system database.

17. A computer-readable medium having at least computer-executable program code tangibly embodied therein for creating an online address book on a system database over a network, said computer executable program code comprising:
a) computer program code for creating a user account on the system by inputting name, login and password, and user's contact information; inputting connection information for a first online address book; and providing proof that user has access rights to the online address book account;
b) computer program code for accessing said online address book data via the network; and importing the stored contact information into the system database;
c) computer program code for a user to set privilege levels for visibility of user contact information by addressees;
d) computer program code for repeating steps (a) through (c) until all of a user's online address books are imported into the system server; and,
e) computer program code for creating relationship tables between a user and addressees within said address book.

18. The computer readable medium of claim 17, wherein setting privilege levels comprises a user granting access to each data element of a user's contact information in a manner customized for an addressee.

19. The computer readable medium of claim 17, wherein setting privilege levels comprises a user granting access to the types of data elements of a user's contact information based on an addressee's category of relationship to the user.

20. A computer-readable medium having at least computer-executable program code tangibly embodied therein for updating an online address book comprising a user's online email accounts, social network accounts, and personal information manager accounts on a system database over a network, said computer executable program code comprising,
a) computer program code for on a client computer, inputting an update to a data element in user's contact information; and transmitting said update to user's account stored on the system database;
b) computer program code for on a system computer, identifying which addressees may receive the user's update based on privilege levels designated for each addressee;
c) computer program code for determining that if said identified addressees: (i) have an account on the system database, and (ii) have setup their account to automatically receive updates into their online address books and social network accounts.

21. The computer readable medium of claim 21 further comprising, computer program code for if addressee has an account on the system database and has setup said account to automatically receive updates, logging into said addressees online address books and social network accounts and automatically updating user's contact information.

22. The computer readable medium of claim 21 further comprising, computer program code for if addressee does not have an account on the system database, transmitting an email to said identified addressee requesting they input user's updated contact information into their online address books and social network accounts.

23. The computer readable medium of claim 21 further comprising, computer program code for if addressee does have an account on the system database, but did not setup said account to permit automatic updates, transmitting an email to said identified addressee requesting they input user's updated contact information into their online address books and social network accounts.
